(19) United States
(12) Patent Application Publication
(10) Pub. No.: US 2017/0228781 A1
(43) Pub. Date: Aug. 10, 2017

(54) SYSTEMS AND METHODS FOR IDENTIFYING, INTERACTING WITH, AND PURCHASING ITEMS OF INTEREST IN A VIDEO

(71) Applicant: Hotdot TV, Inc., Sudbury, MA (US)

(72) Inventor: Michael V. Conte, Paris (FR)

(21) Appl. No.: 15/331,291

(22) Filed: Oct. 21, 2016

Related U.S. Application Data
(63) Continuation of application No. 14/219,511, filed on Mar. 19, 2014, now abandoned.

(30) Foreign Application Priority Data
Feb. 24, 2014 (EP) 14305252.0

(51) Int. Cl. G06Q 30/02; G06Q 50/00; H04N 21/431; H04N 21/84; H04N 21/478; H04N 21/61

(52) U.S. Cl. CPC G06Q 30/0257; H04N 21/47815; H04N 21/6106; H04N 21/4312; H04N 21/84; G06Q 50/01; G06Q 30/0273; G06Q 30/0275

(57) ABSTRACT

Systems and methods for identifying, interacting with, and purchasing items of interest in video content. A plurality of video image frames are provided to a user, and a selection of one of the image frames is received and displayed. One or more selectable visual indicators are displayed on the selected image frame, with at least one of the visual indicators being associated with a product or service shown in the image frame. The user can select one of the visual indicators to be directed to information about the product or service, including where the product or service can be purchased.

### CROSS-REFERENCE TO RELATED APPLICATION

This application is a continuation of U.S. patent application Ser. No. 14/219,544, filed on Mar. 19, 2014, and entitled “Systems and Methods for Identifying, Interacting with, and Purchasing Items of Interest in a Video,” which claims priority to and the benefit of European Patent Application No. EP14305252, filed on Feb. 24, 2014, and entitled “Systems and Methods for Identifying, Interacting with, and Purchasing Items of Interest in a Video,” the entireties of which are incorporated by reference herein.

### BACKGROUND

The present disclosure relates generally to systems and methods for identifying and purchasing items of interest in a video and, more particularly, to systems and methods for providing visual indicators on image frames of a video that a user can select to be directed to products, services, and/or other information associated with the video, the selected visual indicator and/or the image frame on which it appears.

Advances in media streaming and communications technology have resulted in an increasing number of devices, such as tablets, smartphones, televisions, computers, and game consoles, being globally connected. Furthermore, users are increasingly relying on these devices to provide and interact with media content such as movies and television shows. Users can also access social media sites using their devices, and can share and comment on the media content that they view. Many of these activities are tracked and are used to target advertisements to the users.

However, current revenue models that rely on advertising to such users suffer from the effects of ad-blocking, time-shifting, and piracy, among other challenges. In these and other situations, user engagement data does not reach content creators or advertisers. Moreover, trying to overcome this problem by forcing ads onto users only pushes them further away.

### BRIEF SUMMARY

Systems and methods are presented for identifying, engaging with, and purchasing items of interest shown in or related to a video. Users watching a video on a device can use the same or a different device to select a particular image frame in the video. The image frame can include visual indicators, such as red circles, that are overlaid on or near items of interest in the image. The items of interest can be, for example, products or services used by actors in the video, or other intangible items, such as the location of a scene or music playing during that scene in the video. Users can interact with the visual indicators to receive more information about the items of interest and to purchase the same or similar products and services.

In one aspect, a computer-implemented method includes providing a plurality of image frames of a video; receiving a selection of one of the image frames; displaying the selected image frame to a user of a device; and displaying one or more selectable visual indicators on the selected image frame, at least one of the visual indicators being associated with a product or service shown in the image frame.

In one implementation, the method further includes receiving a selection, by the user, of the at least one visual indicator; and directing the user to information relating to the product or service shown in the selected image frame. The information can include a website where the user can purchase at least one of the product or service shown in the image frame and products or services similar to the product or service shown in the image frame.

In another implementation, a second one of the visual indicators is associated with an intangible comprising at least one of a location shown in the selected image frame, a soundtrack associated with the video, and a song playing during a scene in which the selected image frame appears. The method can further include receiving a selection, by the user, of the second visual indicator; and directing the user to a website where the user can purchase a product or service relating to the intangible.

In a further implementation, a third one of the visual indicators is associated with a person or character shown in the selected image frame. The method can further include receiving a selection, by the user, of the third visual indicator; and directing the user to information relating to the person or character shown in the selected image frame, wherein the information comprises products or services used by the person or character in at least one of the selected image frame, the video, and other videos in which the person or character appears.

In one implementation, the method further includes, prior to providing the image frames to the user, providing a searchable and/or browseable database of information associated with video content; and receiving a selection, by the user, of the video from the database.

In yet another implementation, the method further includes, prior to providing the image frames to the user, capturing at least a portion of the video, the portion comprising at least one of a video segment, an audio segment, and an image; and identifying the video based on the captured portion, wherein the selected image frame of the video corresponds the to the captured portion.

Various implementations of the method include one or more of the following features. The method can further include bookmarking the selected image frame such that the user can easily return to the selected image frame at a later time. The method can further include facilitating sharing of at least one of the image frames and the visual indicators via a social network. The method can further include receiving a request for a new visual indicator to be added to at least one of the image frames; and adding the new visual indicator to the at least one of the image frames based on the request. Adding the new visual indicator can include placing the new visual indicator on the at least one of the image frames at a position relative to a size of the image frame and at a time relative to a length of the video. The method can further include collecting data based on actions taken by the user with respect to the image frames and the selectable visual indicators.

Further implementations of the method include one or more of the following features. The method can further include compensating a content creator associated with the video based at least in part on the collected data. The method can further include receiving compensation from an advertiser associated with the video based at least in part on the collected data. An advertiser can be associated with at least one of the visual indicators. The method can further include providing an advertisement auction to a plurality of advertisers in which the advertisers can bid to have selectable visual indicators associated with a product or service displayed on an image frame of a video.

In another implementation, the method further includes presenting the video to the user via a video player application on the device. The device can be a smartphone, a tablet, a laptop, a personal computer, smart glasses, or a smart watch. The video can be presented to the user via a second device. The second device can be a television or a projector. The video can be a television episode and/or a movie. The product can be apparel, jewelry, a beauty product, a food, a beverage, a vehicle, a consumer electronics product, a publication, a toy, a furnishing, or artwork. The visual indicators can include colored shapes overlaid on the selected image frame.

In another aspect, a system includes one or more computers programmed to perform operations including providing a plurality of image frames of a video; receiving a selection of one of the image frames; displaying the selected image frame to a user of a device; and displaying one or more selectable visual indicators on the selected image frame, at least one of the visual indicators being associated with a product or service shown in the image frame.

In one implementation, the operations further include receiving a selection, by the user, of the at least one visual indicator; and directing the user to information relating to the product or service shown in the selected image frame. The information can further include a website where the user can purchase at least one of the product or service shown in the image frame and products or services similar to the product or service shown in the image frame.

In another implementation, a second one of the visual indicators is associated with an intangible comprising at least one of a location shown in the selected image frame, a soundtrack associated with the video, and a song playing during a scene in which the selected image frame appears. The operations can further include receiving a selection, by the user, of the second visual indicator; and directing the user to a website where the user can purchase a product or service relating to the intangible.

In a further implementation, a third one of the visual indicators is associated with a person or character shown in the selected image frame. The operations can further include receiving a selection, by the user, of the third visual indicator; and directing the user to information relating to the person or character shown in the selected image frame, wherein the information comprises products or services used by the person or character in at least one of the selected image frame, the video, and other videos in which the person or character appears.

In one implementation, the operations further include, prior to providing the image frames to the user, providing a searchable and/or browseable database of information associated with video content; and receiving a selection, by the user, of the video from the database.

In yet another implementation, the operations further include, prior to providing the image frames to the user, capturing at least a portion of the video, the portion comprising at least one of a video segment, an audio segment, and an image; and identifying the video based on the captured portion, wherein the selected image frame of the video corresponds the to the captured portion.

Various implementations of the system include one or more of the following features. The operations can further include bookmarking the selected image frame such that the user can easily return to the selected image frame at a later time. The operations can further include facilitating sharing of at least one of the image frames and the visual indicators via a social network. The operations can further include receiving a request for a new visual indicator to be added to at least one of the image frames; and adding the new visual indicator to the at least one of the image frames based on the request. Adding the new visual indicator can include placing the new visual indicator on the at least one of the image frames at a position relative to a size of the image frame and at a time relative to a length of the video. The operations can further include collecting data based on actions taken by the user with respect to the image frames and the selectable visual indicators.

Further implementations of the system include one or more of the following features. The operations can further include compensating a content creator associated with the video based at least in part on the collected data. The operations can further include receiving compensation from an advertiser associated with the video based at least in part on the collected data. An advertiser can be associated with at least one of the visual indicators. The operations can further include providing an advertisement auction to a plurality of advertisers in which the advertisers can bid to have selectable visual indicators associated with a product or service displayed on an image frame of a video.

In another implementation, the operations further include presenting the video to the user via a video player application on the device. The device can be a smartphone, a tablet, a laptop, a personal computer, smart glasses, or a smart watch. The video can be presented to the user via a second device. The second device can be a television or a projector. The video can be a television episode and/or a movie. The product can be apparel, jewelry, a beauty product, a food, a beverage, a vehicle, a consumer electronics product, a publication, a toy, a furnishing, or artwork. The visual indicators can include colored shapes overlaid on the selected image frame.

The details of one or more implementations of the subject matter described in the present specification are set forth in the accompanying drawings and the description below. Other features, aspects, and advantages of the subject matter will become apparent from the description, the drawings, and the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the implementations. In the following description, various implementations are described with reference to the following drawings, in which:

FIG. 1 is a high-level system architecture diagram according to an implementation.

FIG. 2 is a flowchart of an example method for identifying, interacting with, and purchasing items of interest in a video.

FIG. 3 is an example graphical user interface of an application on a mobile device.

FIG. 4 is an example graphical user interface of an application on a mobile device.

### DETAILED DESCRIPTION

Described herein in various implementations are systems and accompanying methods for allowing a user who is watching (or has watched) a video program on a device to identify items of interest that appear in and/or are related to the video through selectable visual indicators that appear on image frames of the video. The present system can, for example, provide information to the user about the items of interest, direct the user to a website where products or services related to the items of interest can be purchased, and allow the user to share items of interest and videos scenes via social networks and applications (e.g., Facebook, Reddit, Twitter). The items of interest can be a tangible or intangible object or concept having some association with a particular scene of a video, a still image frame of a video, and/or the video itself. For example, an item of interest can be a product shown in the video, such as apparel, jewelry, a beauty product, a food, a beverage, a vehicle, a consumer electronics product, a book, a toy, a furnishing, artwork, and so on. An item of interest can also be a service or a provider of a service shown in the video, such as a hotel, restaurant, theater, food delivery service, and so on. Items of interest can also include intangible items, such as a location shown in the video, or a soundtrack or song that plays during the video. As another example, an item of interest can be a person (e.g., actor, spokesperson, performer, newscaster, athlete, etc.) or character (e.g., Gandalf, Fred Flintstone, Lassie, etc.) that appears in the video.

A user might be interested in, for example, what dress a character is wearing at a particular scene in a movie, or she might want to share the scene or the dress with a friend, or she might want to purchase the dress. Similarly, the user might be interest in other objects or aspects of any moment in the video, such as identifying what music is playing, placing a scene on a map (real or fictional), learning more about a character or an actor that plays the character, what products and services the character or actor uses in the video or in other videos, and so on. These and other items of interest can be identified on individual video image frames using selectable visual indicators that a user can interact with by, e.g., tapping a touchscreen, clicking a mouse, and so on.

The visual indicators can be graphical shapes, images, icons, or other suitable indicator overlaid on an image frame of a video (and/or proximate an image frame on a graphical user interface). The visual indicators can be solid or partially transparent, and can change in size, shape, color, or other properties when hovered over, selected, or otherwise or interacted with. For example, the visual indicators can be red circles overlaid on a video image frame at specific x- and y-coordinates by pixel, or other absolute or relative positioning method (e.g., a red circular outline can be positioned at coordinates corresponding to a product shown in the image frame). Visual indicators can be positioned independent of the encoding of the video and image frames. For example, a visual indicator can be specified as appearing from time 10% to time 11% relative to the length of the video content, and appearing 35% down and 45% over, from the top-left corner, relative to the size of the image frame. In this manner, a visual indicator can be correctly located regardless of whether the video includes image frames that are standard definition, high definition, having a frame rate of N (e.g., one) frames per second, and/or actual video footage. Other types of visual indicators are and positioning methods are possible.

The video can include various forms of video media content, with or without accompanying audio content, provided via a suitable medium, such the Internet, a cable or satellite network, a computer-readable medium (e.g., digital file, DVD, Blu-ray disc), and the like. For instance, the video can include a television show, a movie, a live broadcast, a sporting event, a concert, a news program, a commercial, a video clip (e.g., a Youtube video), an animation, or other form of entertainment or informational video media. The video can also be recorded, streaming, and so on, as the present system does not require control over the form or source of the video.

Videos can be viewed using a device having an associated output display screen, such as a television, a projector, a smartphone, a tablet, smart glasses, a smart watch a gaming console, a laptop, a personal computer, and the like. A user can interact with screenshots from a video to identify, engage with, and potentially purchase items of interest shown in or related to a particular screenshot or the video itself using the same device on which the video is viewed or a different device, provided, in either case, that the device is able to receive input from the user (e.g., via a touchscreen, touchpad, keyboard, mouse, remote control, or other input device).

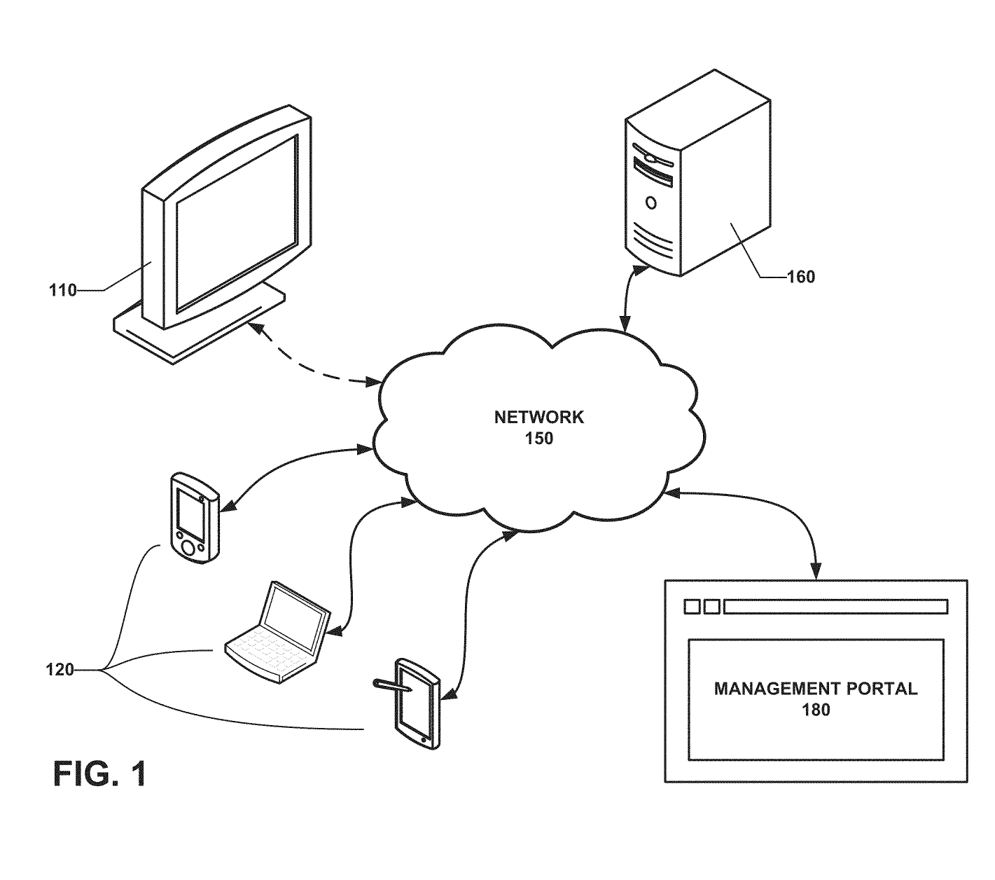

One implementation of a system providing the functionality described herein is depicted in FIG. 1. The system includes a client or front-end application that runs on a user's smartphone, tablet, personal computer, or other device 120. Generally, the client application facilitates the user's identification and interaction with visual indicators on video image frames, and provides a way to browse and share social interactions among other users. More specifically, the client application manages the download, caching, and presentation of video image frames and accompanying metadata (e.g., the placement and links associated with visual indicators displayed on image frames), as well as the providing of notifications to a user and facilitation of interactions such as creating and deleting bookmarks.

The client application also provides an interface to a catalog or database containing information associated with videos. For example, the catalog can include and be browseable and/or searchable by title, actor, character, products or services shown in the video, filming location, and so on. A user can interact with the catalog through the client application to find, e.g., a movie scene in which Leonardo DiCaprio wears an Armani suit, then bring a up a screenshot of the particular scene, select a visual indicator on the suit, and be directed to a website where the same or a similar suit can be purchased. In some implementations, the user device 120 acts as the primary video player of the content, and visual indicators can be displayed, e.g., when the video is paused. In other implementations, however, the video is viewed on another video display device (e.g., television 110) separate from the user device 120. In some circumstances, the user device 120 can also act as a remote control, to direct playback of the video on the separate video display device 110 (e.g., pause, play, stop, rewind, fast-forward, jump to a selected scene, etc.).

One or more backend servers 160 provide functionality for ingesting original video content to produce the video image frame summary (e.g., screen captures) for a video and audio/video fingerprinting (so that a video can be recognized by capturing and analyzing an audio and/or video portion of the video. The screen captures, which can be video image frames separated by a time period (e.g., 1 second, 2 second, 5 seconds, etc.) provide a rich and easy way for users to quickly browse video content to find items of interest. The video image frame summary data is much smaller than the complete media and, as such, is easier to distribute, especially to mobile devices with lower bandwidth connections. The backend server 160 can include a content delivery system to provide, on demand, screen captures of a video and any associated metadata (e.g., visual indicators), as well as notifications to user devices 120. The client application on a user device 120 can handle requesting screen captures and metadata from the backend server 160 at an appropriate fidelity and caching it locally on the user device 120.

In one implementation, the backend server 160 includes an authoring system for creating visual indicators and assigning them to scenes and items. The visual indicators can have a relative x, y position in an image frame and a relative time range within the content (e.g., x=10% of image from left side, y=20% of image from top side, displayed between timestamp 30:15 and 31:01). In some implementations, some visual indicators, such as music, do not have an x, y position. Regardless of the sample rate and resolution of the content, the visual indicators can be placed accurately. Using the authoring tool, a simple trajectory over time can be described (i.e., the object starts at x1, y1 and ends at x2, y2), making tagging more efficient. For example, if a video shows a car driving down a highway from the left side of the screen to the right, a visual indicator can be associated with the car's trajectory over time. A visual indicator can be placed on the car on the left side of the screen at a starting time, and then specified as being on the same car on the right side of the screen at an ending time. The system can then draw a simple trajectory to move the visual indicator from the left to the right over the set of frames occurring between the starting and ending times. Complex trajectories are also possible. As the system learns to recognize objects in video image frames, visual indicators can be suggested automatically.

Automated recognition of objects of interest can be performed using one or more of various techniques, including edge detection/contrast to discern independent objects in the screen, pattern matching to previously tagged objects and objects in the video information catalog, hints supplied by users requesting new visual indicators or modifications to existing visual indicators, appearances of the same object in the same media (e.g., a character wears the same watch throughout a video or a portion thereof, so that after tagging one or more initial appearances, later appearances are tagged automatically), and facial recognition of persons or characters in video content (allowing for automatic suggestions of the same or similar links for the same character, e.g., if the character is often wearing the same items). In one implementation, an asset list received from a production company is used so that the universe of possible objects is narrowed. Thus, for example, even in the case where the system has never seen a particular dress, it could suggest one of the ten dresses known to appear in the episode In the case of music, audio fingerprinting can be used.

The backend server 160 can maintain user profiles, preferences, bookmarks, user interaction data, and so on, all of which can also be cached on respective user devices 120. This and other data associated with users can be collected, culled, processed, and/or analyzed to provide analytical information useful to advertisers. More specifically, the backend server 160 can include a reporting system for billing as well as social engagement. Via data mining, the system can provide insights such as which scenes, visual indicators, actors, locations, characters, products, services, music, and so on, are the most interesting (by, for example, tracking the engagement (e.g., dwell time, gaze tracking, user interaction, etc.) as a percentage of exposure, and how that grows or decays over time). The insights can be used to determine a QB rating or similar rating, which evidences how much a visual indicator/item of interest is loved or hated, and can be normalized against views so that lesser viewed content still has correctly identified hot items. This “heat factor” can rank users' interest and provide key insights to content creators and sellers on a free or paid basis. Further, the collected information can be cross referenced with time, demographics, location, engagement level, and so on, such that a more complete picture of users and their interests can be created and categorized.

In one implementation, the backend server 160 includes a marketplace to connect advertisements to visual indicators and the users who select them. This can, for example, include several ad units: a direct link from selecting the visual indicator, a suggested link related to a visual indicator, and a featured placement related to a show, scene or character. A relevancy mechanism can also be used to match sellers with visual indicators. For example, advertisers and sellers of products and services can initially be matched to visual indicators shown on video image frames by category (e.g., apparel, food, consumer electronics, etc.), or other characteristics, and priced via a rate card. Advertisers can also target users of the system according to statistical data based on impressions, clicks, and conversions, as well as data gathered and associated with users in user profiles, such as demographics, geography, interests, browsing history, and so on.

As more data is accumulated, opportunities for advertisers and sellers can be algorithmically ranked according to relevance as measured by, for example, user engagement, and priced via an auction. For example, the system can create or have access to an authoritative list of products and services in media content (e.g., costumes, props, etc.). The items can be cataloged and matched to the same or similar items sold by merchants. In the case where there are multiple merchants that sell an item, a link to the highest-bidding merchant can be provided to a user in real time. Bid value can be measured along with other factors such as customer satisfaction and purchase completion to better rank merchants and determine which to refer a user to. Rankings can vary according to time, location, stock availability, reputation, user preference (price vs. speed), bid value, and so on. The system can also provide users with multiple choices (e.g., “These three sellers have this dress . . . ”), as the users may choose different merchants based on shipping speed, price or brand. In one implementation, merchants receive the lists of products, services, and other items of interest associated with video content, and the merchants can specify those that they want to bid on, along with creative choices like promotional text (e.g., “10% with discount code”).

The backend functionality described above, including system configuration, content ingestion and upload, authoring, and editing and maintenance of the video information catalog can be performed via a remotely-accessible management portal 180 (e.g., web-based interface).

A communications network 150 can connect the user devices 120 with one or more backend servers 160 and/or with each other. The communication can take place over media such as standard telephone lines, LAN or WAN links (e.g., T1, T3, 56 kb, X.25), broadband connections (ISDN, Frame Relay, ATM), wireless links (802.11 (Wi-Fi), Bluetooth, GSM, CDMA, etc.), for example. Other communication media are possible. The network 150 can carry TCP/IP protocol communications, and HTTP/HTTPS requests made by a web browser, and the connection between the user devices 120 and backend servers 160 can be communicated over such TCP/IP networks. Other communication protocols are possible. In some implementations, the video display device 110 is also connected to a user device 120 and/or backend server 160 via network 160 to provide for, e.g., control over video playback on the display device 110 by a user device 120.

Implementations of the system can use appropriate hardware or software; for example, the system can execute on a system capable of running an operating system such as the Microsoft Windows® operating systems, the Apple OS X® operating systems, the Apple iOS® platform, the Google Android™ platform, the Linux® operating system and other variants of UNIX® operating systems, and the like.

Some or all of the functionality described herein can be implemented in software and/or hardware on a user's device 120. A user device 120 can include, but is not limited to, a smart phone, smart watch, smart glasses, tablet computer, portable computer, television, gaming device, music player, mobile telephone, laptop, palmtop, smart or dumb terminal, network computer, personal digital assistant, wireless device, information appliance, workstation, minicomputer, mainframe computer, or other computing device, that is operated as a general purpose computer or a special purpose hardware device that can execute the functionality described herein. The software, for example, can be implemented on a general purpose computing device in the form of a computer including a processing unit, a system memory, and a system bus that couples various system components including the system memory to the processing unit.

Additionally or alternatively, some or all of the functionality can be performed remotely, in the cloud, or via software-as-a-service. For example, as described above, certain functions can be performed on one or more remote backend servers 160 or other devices, as described above, that communicate with the user devices 120. The remote functionality can execute on server class computers that have sufficient memory, data storage, and processing power and that run a server class operating system (e.g., Oracle® Solaris®, GNU/Linux®, and the Microsoft® Windows® family of operating systems).

The system can include a plurality of software processing modules stored in a memory and executed on a processor. By way of illustration, the program modules can be in the form of one or more suitable programming languages, which are converted to machine language or object code to allow the processor or processors to execute the instructions. The software can be in the form of a standalone application, implemented in a suitable programming language or framework.

Method steps of the techniques described herein can be performed by one or more programmable processors executing one or more computer programs to perform functions by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors. Generally, a processor will receive instructions and data from a read-only memory or a random access memory or both. The essential elements of a computer are a processor for executing instructions and one or more memory devices for storing instructions and data. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. One or more memories can store media assets (e.g., audio, video, graphics, interface elements, and/or other media files), configuration files, and/or instructions that, when executed by a processor, form the modules, engines, and other components described herein and perform the functionality associated with the components. The processor and the memory can be supplemented by, or incorporated in special purpose logic circuitry.

In various implementations, a user device 120 includes a web browser, native application, or both, that facilitates execution of the functionality described herein. A web browser allows the device to request a web page or other downloadable program, applet, or document (e.g., from the backend server(s) 160 or other server, such as a web server) with a web page request. One example of a web page is a data file that includes computer executable or interpretable information, graphics, sound, text, and/or video, that can be displayed, executed, played, processed, streamed, and/or stored and that can contain links, or pointers, to other web pages. In one implementation, a user of the device manually requests a web page from the server. Alternatively, the device automatically makes requests with the web browser. Examples of commercially available web browser software include Microsoft® Internet Explorer®, Mozilla® Firefox®, and Apple® Safari®.

In some implementations, the user devices 120 include client software. The client software provides functionality to the device that provides for the implementation and execution of the features described herein. The client software can be implemented in various forms, for example, it can be in the form of a native application, web page, widget, and/or Java, JavaScript, .Net, Silverlight, Flash, and/or other applet or plug-in that is downloaded to the device and runs in conjunction with the web browser. The client software and the web browser can be part of a single client-server interface; for example, the client software can be implemented as a plug-in to the web browser or to another framework or operating system. Other suitable client software architecture, including but not limited to widget frameworks and applet technology can also be employed with the client software.

The system can also be practiced in distributed computing environments where tasks are performed by remote processing devices that are linked through a communications network. In a distributed computing environment, program modules can be located in both local and remote computer storage media including memory storage devices. Other types of system hardware and software than that described herein can also be used, depending on the capacity of the device and the amount of required data processing capability. The system can also be implemented on one or more virtual machines executing virtualized operating systems such as those mentioned above, and that operate on one or more computers having hardware such as that described herein.

In some cases, relational or other structured databases can provide such functionality, for example, as a database management system which stores data for processing. Examples of databases include the MySQL Database Server or ORACLE Database Server offered by ORACLE Corp. of Redwood Shores, Calif., the PostgreSQL Database Server by the PostgreSQL Global Development Group of Berkeley, Calif., or the DB2 Database Server offered by IBM.

It should also be noted that implementations of the systems and methods can be provided as one or more computer-readable programs embodied on or in one or more articles of manufacture. The program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

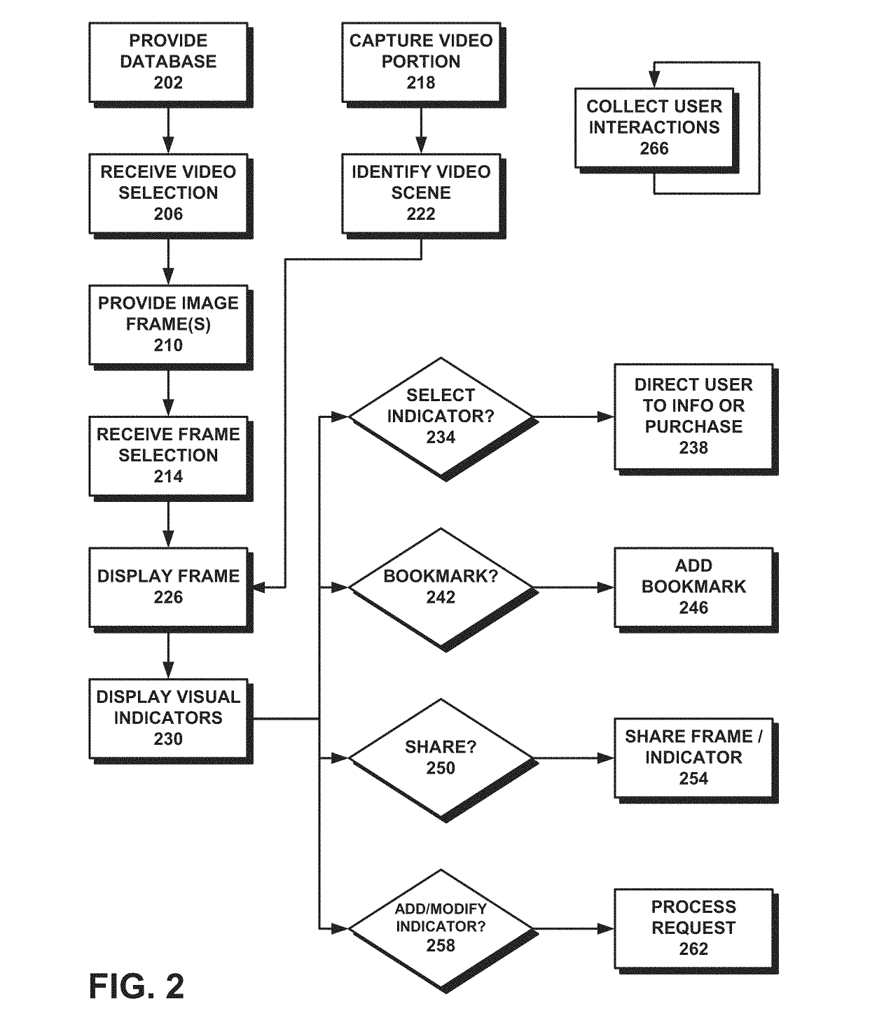

FIG. 2 illustrates an example method for allowing a user to identify, interact with, and purchase items of interest that appear in or are related to image frames of video content. In one implementation, the method is implemented on the system described herein, or a system similar thereto. In STEP 202, the backend server 160 provides a video content catalog and information database, such as that described above, which is browseable and searchable via an application on a user device 120. The application can be used to browse content to locate, for example, television shows, movies, and so on, that are supported (i.e., have associated metadata for displaying visual indicators). When the user locates the desired video content, she can select the particular episode, movie, or other video using the application interface. The selection is sent to the backend server 160 or, if sufficient cached data is available on the user device 120, the application can locally process the selection (STEP 206). In either case, the application provides the user with a visual display of individual image frames of the video content, which provide a visual summary of the content (STEP 210). The user can scroll through or manipulate the image frames to locate a desired scene or moment in the video content. Once the user has located the desired image frame, she can select the frame by, e.g., clicking or tapping on it, and the application receives the selection (STEP 214).

As an alternative option, a user can use her device (e.g., smartphone, tablet, etc.) to capture a portion of a video (e.g., image, audio, and/or video) that is current playing, whether on the same device or a different device (e.g., a television) (STEP 218). As one example, a user is watching the a show on TV, sees an item of interest, and uses her smartphone to identify the scene by recording video and/or audio, or taking a picture of the show. The captured data can be processed locally or by a remote server to determine an audio and/or video fingerprint of the captured video content. Based on the fingerprint(s), the corresponding scene and an associated image frame can be identified (STEP 222). Surrounding image frames and/or a portion of or the fully visual summary of frames can also be provided to the user in case, for example, the user captured the audio/video portion too late.

In browsing a visual summary of image frames, a user can select a particular image frame or range of image frames to locate a scene of interest. In some implementations, as the user manipulates (e.g., drags through) screenshots, visual feedback can be displayed indicating that a particular image frame or group of frames includes selectable visual indicators. For example, a scrollbar can change from translucent to solid, grow in size, change in color, or other suitable visual or audio feedback. When a user nears a scene with a visual indicator, a slider can snap to the corresponding frame. The snapping action can be performed when, for example, the user nears the corresponding frame within a percentage of the total time range of the video or the time range represented by the image frame. Users can also add filters, search terms, or otherwise specify which types of visual indicators or comments they are interested in. Thus, when browsing a visual summary of frames, the snapping action can occur when the user nears a frame having visual indicators or comments corresponding to the desired types. Other visual feedback for locating relevant image frames is possible, such as placing tick marks on a slider bar, expanding or magnifying the area under a user's finger or pointer as she manipulates the image frames, zooming in on nearby frames, and so on.

Whether the image frame was automatically identified based on a fingerprint, or selected by the user from a visual summary, as described above, the image frame is displayed to the user on the user device 120 (STEP 226). In STEP 230, one or more selectable visual indicators associated with the scene, image frame, video, audio and/or items of interest can be displayed on the selected or identified video image frame. The visual indicators can automatically appear as the image frame is displayed, or can be toggled by the user via an interface control, such as a graphical button that can be clicked or tapped. As described above, the visual indicators can be associated with products and/or services that appear in the image frame, products and/or services that are associated with an object, person, or place that appears in the image frame, intangible or invisible objects associated with the image frame or video (e.g., music, general location, etc.), and so on. Upon a user's selecting a visual indicator (STEP 234), the user can be directed to information relating to the visual indicator and the object or concept that it represents (STEP 238).

For example, if selecting a visual indicator associated with a product or service, the user can be directed to a webpage (or other information source) that provides information about the product or service, and provides links to where the product or service, or similar products or services, can be purchased. As another example, if a visual indicator associated with an actor is selected, the user can be directed to webpage that describes the actor, lists the movies, television shows, and other content that actor has appeared in, lists the products and services used by the actor in the current video and other videos, and so on. The webpage can also include links to purchase such products and services and similar products and services. In the case of a visual indicator associated with music, the user can be directed to a webpage where the soundtrack or an individual song that appears in the video can be purchased. For a visual indicator associated with a location, the user can be directed to webpages describing the location, mapping it, and offering nearby hotel rooms or vacation packages for the user to purchase.

Users can also be directed to a webpage where they can gift a product or service to another person. Public and/or private wish list functionality can also be provided such that users, friends, and/or the general public can purchase gifts for users based on items existing in the users' wish lists. In some implementations, the system provides a wallet functionality, where users can purchase stored value that can be used at a later time to buy products and services or other items of interest. The stored value can also be gifted to other users; for example, a parent might give a child $50 credit for a birthday, or a $25 a month budget for items purchased via the visual indicators. As such, even users who do not have a credit card can use the system for purchases. The stored value can be paid to the system provider by the gifter, and then transferred to the appropriate merchant on a purchase. A handling or other fee can be deducted from the transfer. The stored value can also be available should either merchants or content creators want to credit particular users who either win a contest or satisfy some engagement level. Merchants and content creators can similarly can generate promotional codes, good for discounts, to grant to users.

Using an application user interface on the user device 120, the user can take various other actions. In one implementation, the user can choose to bookmark the displayed image frame or a particular item of interest (STEP 242), and the application will save the user's place (STEP 246) so that the same image frame or item of interest can easily be returned to at a later time. The user can also request the system to provide her with notifications (e.g., via email, text messaging, chat, etc.) when a particular item of interest, or a related item of interest, appears in other video content, when a product or service related to an item of interest is on sale, when a requested visual indicator has been added to video content, and so on. Users can also elect to receive notifications from, e.g., a particular show (including via characters on the show) who can give the users recommendations (e.g., watch this show), notify the users of sales and other promotions, offer invitations (e.g., come to this event or like this page), and so on. The system can infer and automatically create or suggest, based on information collected about the user (described further below), these notifications to users, as well as infer what a user may be interested in, and provide reminders to the user that new video content of interest is available (e.g., a new television episode), or that certain products or services recommended for the user appear in existing or upcoming video content. Some notifications can be provided to users free of charge or as a paid service.

A user can also decide to share and/or comment on a particular image frame, a video clip, a visual indicator, and/or an item of interest associated with a visual indicator via a social network (STEPS 250 and 254). For example, the user can share a 30-second scene with a friend who also watches the show, or post a comment about an item of interest in the scene. In addition to being associated with an item of interest or visual indicator in an image frame, comments can be associated with a time and position in which the item or visual indicator appears, relative to the length and/or resolution/size of the video. A user can also comment on and rate visual indicators to express to other users her recommendation of the indicator or an item of interest associated therewith. As a result, the user can interact with other fans of the video content who can also leave comments (which can be linked to a time and position in the video), while helping the system to improve user recommendations. In some implementations, content owners, creators, providers and/or other parties can place restrictions on a user's ability to share content. Users can also “like” a particular moment, scene, character, costume, location, song, and so on. Comments can further be published to users' social media accounts, including to specific friends or groups of friends, or to the public.

In some implementations, users can request information about an item of interest that does not have an associated visual indicator. For example, a selects a movie scene on her user device 120 in which a character uses a Bluetooth headset to make a phone call, but she discovers that there is no visual indicator associated with the headset. Using the application interface, the user can request that a visual indicator be added to the image or a sequence of images (STEP 258). She can specify the appropriate times and position(s) on the image(s) where the visual indicator should appear, as well as provide information about the headset, or links to such information, including one or more links to where the headset can be purchased. If, instead, the user is not in possession of information about the item of interest, she can make a simple request that a visual indicator be considered for the item (e.g., what kind of headset is this actor using?)

Requests for a new visual indicator (as well as feedback regarding suggested modifications and corrections of existing visual indicators and/or the information associated therewith) can be routed to the backend server 160 for automated or manual evaluation by one or more metadata editors. For example, users can vote that a visual indicator is inaccurate or inappropriate (e.g., link is wrong, positioning is incorrect, content or link is inoffensive). Users can also suggest better vendors for a product or service, or alternate products or services if the original is no longer available. Metadata editors can then act on user requests and feedback to add and edit visual indicators and the associated information, including correcting or removing visual indicators or supplying relevant suggestions.

If the user is a trusted user (e.g., is a knowledgeable user who has made prior approved requests), or a threshold number of have made the same or a similar request, the addition or modification of a visual indicator can be automatically approved or subject to less scrutiny. In some implementations, the answers to requests can be crowd-sourced. For example, a user can mark an area of a video image frame and request, “What watch is this actor wearing?” The request can then be provided other users, whether or not they have seen the same video content, and responses can be received. If a certain number of users (e.g., 3 users, 10 users, and so on) respond with the same answer, a visual indicator with the answer can be automatically added to the image frame, or otherwise assumed valid and subject to less scrutiny by metadata editors.

In some implementations, content creators can provide metadata with their own video content. In other instances, metadata can be added to existing content. In the case of live content, or content being broadcast for the first time (e.g., a new episode of Game of Thrones), the system can provide metadata content that is made available only after a specified go-live moment appropriate to the user, which can depending on the user's location, local time, and server approval. In this manner, a user can immediately interact with visual indicators as the scenes unfold in real-time on a video display device.

A full or partial visual summary of video content (i.e., a collection of video image frames of the content) can be provided in advance (e.g., for existing video content), and/or can be incrementally or fully provided to a user as content goes live or is otherwise played. The system can provide a “synchronized” mode, in which a user can watch video content and have image frames displayed with associated visual indicators in real-time as the video content progresses. The user can notify the system that she is watching particular content, or the system can automatically detect the content via a capture of an audio/video portion, as described herein, or through another synchronization method (e.g., the user can synchronize the start of playback of video content with the client application, or if the user is watching the video on the same device that has the client application, the application can have knowledge of the video being viewed, or other suitable method). Thus, users (including those who turn off the real-time display of visual indicators) are provided with a way to quickly bookmark scenes and image frames as areas of interest. After the video content is finished, the users can return to the content to further explore any visual indicators. For example, a user can tap a bookmark button when she sees an item of interest but doesn't want to pause a show or become distracted. After the show, this list of bookmarked moments can be explored to identify the items of interest.

In some implementations, a visual summary can include “no spoiler” and/or partial screenshots in which specific frames are temporarily or permanently redacted, removed, blurred, obscured, or otherwise modified to avoid giving away important plot points or other spoilers. Frames can also be redacted, removed, blurred, obscured, or otherwise modified if there are no selectable visual indicators on the frames. Content creators can specify certain images frames to remove or modify, and/or users can provide feedback on image frames that should be removed or modified. In some implementations, even if a frame is modified in a manner described above, any selectable visual indicators on the frame can still display and function normally.

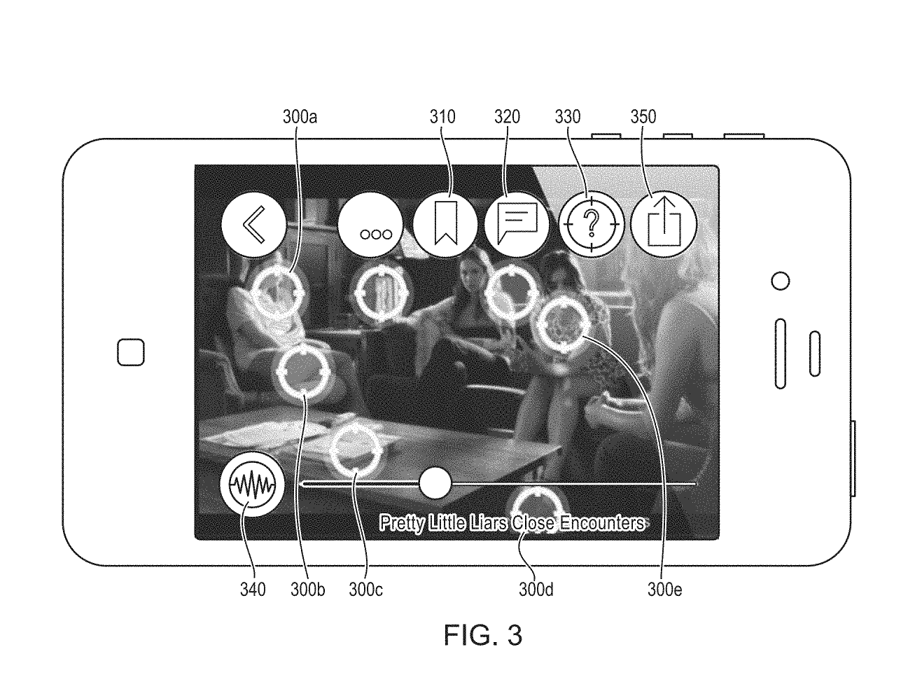

FIG. 3 is an example interface for an application on a user device 120 that allows a user to identify, interact with, and purchase items of interest in video content, as described herein. In this example, the interface includes multiple visual indicators (300a-300e) in the form of red circles overlaid on items of interest on an image frame of a scene in a television show. Visual indicator 300a is placed on an actress in the scene; thus, a user clicking on the indicator 300a could be directed to a webpage having information about the actress, her character, and products or services that she uses in the video. Similar information can be provided for the other visual indicators, where indicator 300b identifies the skirt the actress is wearing, indicator 300c is associated with a magazine on the table, 300d is positioned on the title of the television show and the particular episode, and 300e is placed on the clothing of a different actress. Another visual indicator 340 represent audio associated with scene. For example, by selecting indicator 340, the user can be directed to a webpage where she can purchase a song that is heard playing during the scene.

In other implementations, the visual indicators are visually distinct according to their type or other data. For example, all clothing indicators could be blue, while housewares could be red. As noted above, the system can allow users to filter the kinds of visual indicators that are shown; for example, just show men's fashions, products under $50, products rated highly, or other characteristic relating to an item of interest. Visual indicators can also indicate their relative popularity with other users. For example, popular indicators can be fully filled in or larger than less popular indicators. Indicators can be implemented in various other manners. In one instance, the display of the visual indicators includes a visual “loupe” that the user moves around the screen, and only under that loupe are the certain indicators visible.

In one implementation, content creators, merchants, service providers, and/or the system providers can create custom visual indicators for certain products or services, or special visual indicators, such as indicators used for a game in which users have to locate and select the indicators in order to unlock a feature or receive some value or prize Such special visual indicators could be limited to a number of initial users (e.g., the first 500) as a way to generate interest or urgency for users to engage with the show and the system.

The interface shown in FIG. 3 includes several graphical controls that provide the functionality described above. Button 310 allows a user to bookmark a particular item of interest or image frame. Likewise, button 320 allows the user to share or comment on items of interest or the video content. Requesting information on an item of interest that does not have an associated visual indicator, or modifying an existing visual indicator, can be performed by selecting button 330. The user can also exit the interface using button 350.

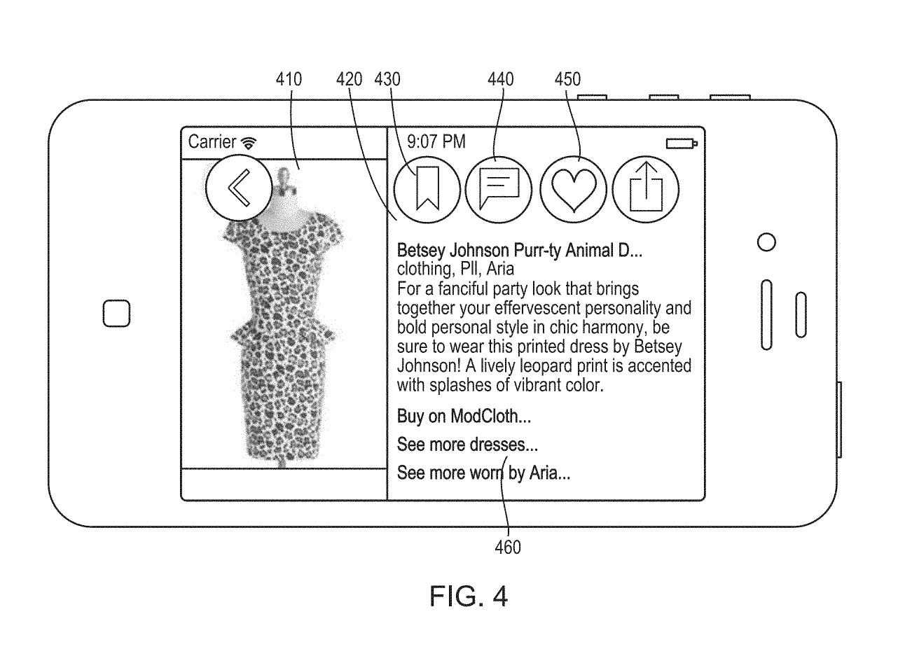

FIG. 4 is an example interface for an information screen that shows after a visual indicator is selected (in this case, a visual indicator associated with a dress a character is wearing in an image frame). The information screen can include an image of the product 410, information about the product 420 (e.g., a marketing description), and links 460 to where a user can purchase the product, find similar products, and find other products used by the character wearing the dress. Similarly to the interface in FIG. 3, the information screen interface can include a button 430 to bookmark the item of interest and a button 440 to comment on or share the item of interest. The interface can also include a button 450 to allow the user to indicate that she likes the item of interest.

Because the visual indicators connect users with information about items of interest in video content they watch, there is significant value in collecting and analyzing data associated with user interactions. Various interactions can be continuously tracked by the system (STEP 266 in FIG. 2), associated with users, and stored in respective user profiles. The collected information can include, but is not limited to, what scenes users have seen, what image frames users have viewed, what users have liked, shared, bookmarked, clicked on and purchased, and so on. Aggregate insights can be provided to content creators and product/service sellers. For example, the system can track the most popular item for sale in a video, the most commented-on scene in a video, the most asked-about item of interest in a video, and so on. For each area of interest, a “heat factor,” can be calculated, indicating the ability to generate interest in users. The insights and related analytical data can be provided to creators and sellers for a fee. Via the insights and tracking, sellers can provide prototype products for use in media, and then, based on achieving a sufficient level of interest in the product, commence to offer it to persons who express interest. Implicit engagement can also be tracked so that, for example, users who interact with the most visual indicators, who purchase the most products, who share the most scenes, and so on, can achieve recognition and be rewarded.

Many visual indicators are likely to be associated with products and services, and these indicators can be of use to interested advertisers who can sell such product or services to users, as well as to content creators who can place products or services in their video content. Ultimately, content creators, merchants, and providers of the present system can benefit from revenue realized from advertisements and product/service placements and sales.

Advertisements can be purchased by advertisers of relevant products and monetized either by impression (e.g., cost-per-mille (CPM), how many see the ad), clicks (e.g., cost-per-click (CPC), how many choose to click on a link), or action (e.g., cost-per-action (CPA), a conversion, how many purchase an item, etc.). Advertisements for related products/services and advertisers can also be displayed, for example, ads for similar dresses or matching accessories. Ad opportunities can also include endorsements of products by characters, regardless of whether the products appear on screen (e.g., a favorite drink or brand of a character). Such ads can be monetized via a bidding auction, or by paid premium placement (e.g., “suggested for you” or “featured”). Providing ad spots for related products is particular useful and valuable for items that are no longer available, such as seasonal fashions. Items can also be cataloged in a scheme, and tags (created by the system provider and/or suggested by users) can be associated with related different items. For example “sundress, floral, funky” can be shared tags, and these tags can be used as an opportunity alongside the actual dress in the show, or associated with a suggested replacement.

In one implementation, the system includes a marketplace of products in need of placement and video content in need of product placements. For example, clothing sellers can offer their lines of spring fashions by uploading their catalog to the marketplace with a sell bid for what they will pay for transactions, clicks, or impressions. Content creators can then choose from among those products to feature in upcoming content or be endorsed by their characters. For some items which exist only ephemerally in the scene, such as cosmetics, fragrances or beverages, product placement can be arranged after the video content has been created.

In some implementations, the system supports crowd-sourced funding for products and services that appear in or are related to items of interest in video content. For example, a fashion house could produce a one-off dress worn in a television show and, using the analytics described herein, the system can measure the interest in the dress and, in some instances, take pre-orders for it. Once a threshold of interest or pre-orders has been reached, the dress can go into production and be sold to the interested users and/or the general public.

The terms and expressions employed herein are used as terms and expressions of description and not of limitation, and there is no intention, in the use of such terms and expressions, of excluding any equivalents of the features shown and described or portions thereof. In addition, having described certain implementations in the present disclosure, it will be apparent to those of ordinary skill in the art that other implementations incorporating the concepts disclosed herein can be used without departing from the spirit and scope of the invention. The features and functions of the various implementations can be arranged in various combinations and permutations, and all are considered to be within the scope of the disclosed invention. Accordingly, the described implementations are to be considered in all respects as illustrative and not restrictive. The configurations, materials, and dimensions described herein are also intended as illustrative and in no way limiting. Similarly, although physical explanations have been provided for explanatory purposes, there is no intent to be bound by any particular theory or mechanism, or to limit the claims in accordance therewith.

1. A computer-implemented method comprising:
providing a plurality of image frames of a video;
receiving a selection of one of the image frames;
displaying the selected image frame to a user of a device; and
displaying one or more selectable visual indicators on the selected image frame, at least one of the visual indicators being associated with a product or service shown in the image frame.

2. The method of claim 1, further comprising:
receiving a selection, by the user, of the at least one visual indicator; and
directing the user to information relating to the product or service shown in the selected image frame.

3. The method of claim 2, wherein the information comprises a website where the user can purchase at least one of the product or service shown in the image frame and products or services similar to the product or service shown in the image frame.

4. The method of claim 1, wherein a second one of the visual indicators is associated with an intangible comprising at least one of a location shown in the selected image frame, a soundtrack associated with the video, and a song playing during a scene in which the selected image frame appears.

5. The method of claim 4, further comprising:
receiving a selection, by the user, of the second visual indicator; and
directing the user to a website where the user can purchase a product or service relating to the intangible.

6. The method of claim 1, wherein a third one of the visual indicators is associated with a person or character shown in the selected image frame.

7. The method of claim 6, further comprising:
receiving a selection, by the user, of the third visual indicator; and
directing the user to information relating to the person or character shown in the selected image frame, wherein the information comprises products or services used by the person or character in at least one of the selected image frame, the video, and other videos in which the person or character appears.

8. The method of claim 1, further comprising, prior to providing the image frames to the user:
providing a searchable database of information associated with video content; and
receiving a selection, by the user, of the video from the database.

9. The method of claim 1, further comprising, prior to providing the image frames to the user:
capturing at least a portion of the video, the portion comprising at least one of a video segment, an audio segment, and an image; and
identifying the video based on the captured portion, wherein the selected image frame of the video corresponds the to the captured portion.

10. The method of claim 1, further comprising bookmarking the selected image frame such that the user can easily return to the selected image frame at a later time.

11. The method of claim 1, further comprising facilitating sharing of at least one of the image frames and the visual indicators via a social network.

12. The method of claim 1, further comprising:
receiving a request for a new visual indicator to be added to at least one of the image frames; and
adding the new visual indicator to the at least one of the image frames based on the request.

13. The method of claim 12, wherein adding the new visual indicator comprises placing the new visual indicator on the at least one of the image frames at a position relative to a size of the image frame and at a time relative to a length of the video.

14. The method of claim 1, further comprising collecting data based on actions taken by the user with respect to the image frames and the selectable visual indicators.

15. The method of claim 14, further comprising compensating a content creator associated with the video based at least in part on the collected data.

16. The method of claim 14, further comprising receiving compensation from an advertiser associated with the video based at least in part on the collected data.

17. The method of claim 1, wherein an advertiser is associated with at least one of the visual indicators.

18. The method of claim 1, further comprising providing an advertisement auction to a plurality of advertisers in which the advertisers can bid to have selectable visual indicators associated with a product or service displayed on an image frame of a video.

19. The method of claim 1, further comprising presenting the video to the user via a video player application on the device.

20. The method of claim 1, wherein the device is selected from the group consisting of a smartphone, a tablet, a laptop, a personal computer, smart glasses, and a smart watch.

21-50. (canceled)
